(19) United States
(12) Patent Application Publication
(10) Pub. No.: US 2017/0225490 A1
(43) Pub. Date: Aug. 10, 2017

(54) HANDHELD PRINTING DEVICE

(71) Applicant: Seiko Epson Corporation, Tokyo (JP)

(72) Inventor: Tomoyuki Kubota, Matsumoto-shi (JP)

(21) Appl. No.: 15/500,924

(22) PCT Filed: Jul. 29, 2015
(86) PCT No.: PCT/JP2015/003829

§ 371 Date: Jan. 31, 2017

(30) Foreign Application Priority Data
Aug. 1, 2014 (JP) 2014-157989

(51) Int. Cl. B41J 3/36

(52) U.S. Cl. CPC B41J 3/36

(57) ABSTRACT

A handheld-type printing device includes an operation unit provided on a first surface side of the printing device. The handheld printing device includes a printing unit which prints an image on a print medium. The printing unit is provided on a second surface side opposite to the first surface side, where the operation unit is provided, and on a near side at the time of operating the operation unit.

### CROSS-REFERENCE TO RELATED APPLICATIONS

This application is the U.S. National Phase under 35 U.S.C. §371 of International Application No. PCT/JP2015/003829 filed on Jul. 29, 2015, which in turn claims the benefit of Japanese Application No. 2014-157989 filed on Aug. 1, 2014, the disclosures of which are expressly incorporated by reference herein.

### TECHNICAL FIELD

The present invention relates to a handheld printing device used in the state of being gripped by the user.

### BACKGROUND ART

Traditionally, a handheld print label preparation device which includes a grip part provided on the near side as viewed from the user of the handheld print label preparation device and a plurality of mechanisms including a motor is known. In this handheld print label preparation device, the plurality of mechanisms is arranged in such a way that the position of the center of gravity of the handheld print label preparation device falls within a position range corresponding to the grip part, thus improving the easiness of grip of the handheld print label preparation device. That is, of the plurality of mechanisms, the motor is provided on the near side of the handheld print label preparation device, and the frame is provided on the far side of the handheld print label preparation device (see JP-2010-274638).

### SUMMARY

The inventor has found the following problem.

In the handheld printing device, a printing unit which prints an image on a print medium has weighty objects such as the frame and the motor, for example. If these weighty objects are arranged in a dispersed manner throughout the entire handheld printing device, even if the position of the center of gravity of the handheld printing device is located within the position range corresponding to the grip part, the handheld printing device easily wobbles when the user grips the near-side part as viewed from the user of the handheld printing device. Therefore, it is difficult to grip the handheld printing device in a stable manner.

An object of the invention is to provide a handheld printing device which can be gripped in a stable manner.

A handheld-type printing device according to the invention includes an operation unit provided on a first surface side of the printing device, and a printing unit which prints an image on a print medium. The printing unit is provided on a second surface side opposite to the first surface side, where the operation unit is provided, and on a near side at the time of operating the operation unit.

According to this configuration, the printing unit is provided on the near side at the time of operating the operation unit. Therefore, the respective components of the printing unit including weighty objects can be put together and arranged on the near side at the time of operating the operation unit. Thus, the weight balance of the printing device can be improved. Therefore, when the printing device is gripped in order to operate the operation unit, the printing device is restrained from wobbling and the handheld-type printing device can be gripped in a stable manner. That is, by setting the center of gravity of the printing device on the side of the operation unit gripped in the case of gripping the printing device in order to operate the operation unit, the printing device can be gripped with a good balance.

In this case, it is preferable that the device further includes a casing where the printing unit is accommodated, that a medium outlet through which a printed print medium is discharged is provided in the casing, and that the medium outlet is provided on the near side at the time of operating the operation unit.

According to this configuration, since the medium outlet is provided on the near side at the time of operating the operation unit of the printing device, the print result on the discharged print medium can be easily visually recognized. Also, the print medium discharged from the medium outlet can be easily picked up and taken out from the medium outlet.

In this case, it is preferable that the device further includes a battery accommodation section where a battery is accommodated, next to the printing unit.

According to this configuration, the battery, which has a high specific gravity, can be put together with the printing unit and thus accommodated with the printing unit on the near side at the time of operating the operation unit. Thus, the weight balance of the printing device can be improved.

In this case, it is preferable that the second surface side of the printing device has a step on a far side at the time of operating the operation unit, compared with the near side at the time of operating the operation unit.

According to this configuration, since the step is provided on the far side at the time of operating the operation unit of the printing device, the printing device can be gripped in a stable manner by placing a finger at the part where the thickness changes at the time of operating the operation unit. Thus, the easiness of grip of the printing device can be improved.

In this case, it is preferable that the device further includes a grip part extending in a direction intersecting with the first surface and the second surface and provided on the near side at the time of operating the operation unit.

According to this configuration, since the grip part is provided on the near side at the time of operating the operation unit, the printing device can be gripped easily.

In this case, it is preferable that the device further includes a loading section for setting the print medium in the printing unit, on the first surface side and on the near side at the time of operating the operation unit.

According to this configuration, the print medium can be put together and arranged with the respective components of the printing unit including weighty objects. Thus, even if the print medium is relatively weighty, the weight balance of the handheld printing device can be improved. Also, the loading section is provided on the first surface side, where the operation unit is provided, the print medium can be easily loaded and replaced in the state where the printing device is gripped.

In this case, it is preferable that an input unit for inputting information to be printed on the print medium is provided in the operation unit.

According to this configuration, at the time of an input operation to the input unit, the pressing force on the input unit can be received by the hand gripping the printing device. Therefore, the input operation to the input unit can be carried out in a stable manner and the printing device can be restrained from wobbling at the time of the input operation.

In this case, it is preferable that a display unit is provided on the far side at the time of operating the operation unit and on the first surface side.

In this case, it is preferable that the printing unit has a motor which serves as a drive source for rotating a roller feeding the print medium, a gear train which transmits a motive power of the motor to the roller, a frame which supports the gear train, and a print head which prints an image on the print medium.

### BRIEF DESCRIPTION OF THE DRAWINGS

FIGS. 1A and 1B are views schematically showing the configuration of a handheld printing device according to an embodiment of the invention. FIG. 1A is a perspective view. FIG. 1B is a right side view.

FIGS. 2A and 2B are views schematically showing the configuration of a handheld printing device according to a first modification. FIG. 2A is a perspective view. FIG. 2B is a right side view.

FIGS. 3A and 3B are views schematically showing the configuration of a handheld printing device according to a second modification. FIG. 3A is a perspective view. FIG. 3B is a right side view

### DESCRIPTION OF EXEMPLARY EMBODIMENTS

Hereinafter, a handheld-type printing device according to an embodiment of the invention will be described, referring the accompanying drawings.

In the description below, the “near side”, “far side”, “front side”, “back side”, “right side”, and “left side” in the illustrations are used. These refer to directions as viewed from the user when the user of the printing device grips a grip part, described later, and operates an operation unit. That is, with respect to the handheld-type printing device, the side close to the user is referred to as the “near side”, and the side far from the user is referred to as the “far side”. Also, the side facing the user is referred to as the “front side”, and the opposite side is referred to as the “back side”. Moreover, the right-hand side when facing the user is referred to as the “right side”, and the left-hand side when facing the user is referred to as the “left side”.

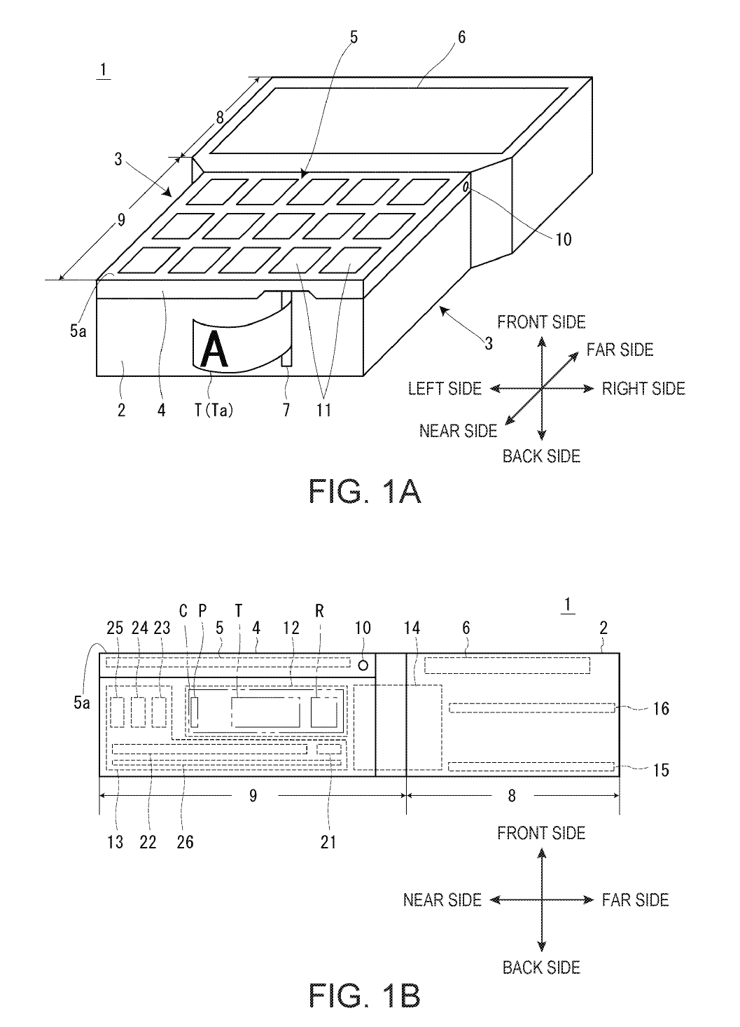

As shown in FIG. 1, a handheld-type printing device (hereinafter referred to as “handheld printing device”) 1 has a casing 2, a grip part 3, an open/close cover 4, a keyboard 5 as an input unit forming an operation unit, and a display unit (hereinafter referred to as “display”) 6.

The casing 2 has a substantially rectangular parallelepiped-like appearance which is long in a direction of connecting the near side of the handheld-type printing device 1 (near side at the time of operating the operation unit) and the far side (far side at the time of operating the operation unit). A tape outlet 7 is provided to the right on the near side surface of the casing 2. The tape outlet 7 is formed in the shape of a slit extending in the direction of the thickness of the casing 2. A printed tape T is discharged from the tape outlet 7.

Here, the tape outlet 7 is an example of the “medium outlet”.

The grip part 3 is provided to the near side on both of the left and right lateral surfaces of the casing 2. That is, in the casing 2, a near-side part 9 is formed with a narrower width than a far-side part 8, and both of the left and right lateral surfaces of the near-side part 9 serve as the grip part 3. The grip part 3 is the part gripped by the user when the user uses the handheld-type printing device 1.

The open/close cover 4 is provided to the near side on the front surface of the casing 2 (first surface where the operation unit is provided). The open/close cover 4 has a substantially rectangular plate-like appearance. The open/close cover 4 opens and closes about a hinge 10 provided at an end part on the far side. As the user opens the open/close cover 4, a cartridge loading section 12 and a battery accommodation section 14, later described, are exposed. The user opens and closes the open/close cover 4 when replacing a tape cartridge C or when replacing a battery.

The keyboard 5 is incorporated in the open/close cover 4. The front surface of the open/close cover 4 is an operation surface 5a of the keyboard 5 where an input operation by the user is carried out. A plurality of keys 11 is provided on the operation surface 5a. The display 6 is provided to the rear side on the front surface of the casing 2. The display 6 displays the result of an input from the keyboard 5 or the like, to the user. The user inputs, from the keyboard 5, characters or the like which the user wants to print, while confirming the result of the input displayed on the display 6.

Moreover, the handheld-type printing device 1 has, inside the casing 2, the cartridge loading section 12, a printing unit 13, the battery accommodation section 14, a power supply unit 15, and a control unit 16.

Here, the cartridge loading section 12 is an example of the “loading section”.

The cartridge loading section 12 is provided on the other side of the keyboard 5 from the operation surface 5a (second surface side in the direction opposite to the first surface where the operation unit is provided). In the cartridge loading section 12, the tape cartridge C is loaded in a removable manner. The tape cartridge C accommodates a tape T as a print medium, an ink ribbon R, and a platen roller P.

The printing unit 13 is, similarly to the cartridge loading section 12, provided on the other side of the keyboard 5 from the operation surface 5a (back side of the operation surface 5a). The printing unit 13 prints an image based on the result of the input from the keyboard 5, onto the tape T reeled off from the tape cartridge C. The printing unit 13 has a motor 21, a gear train 22, a print head 23, a tape cutter 24, a discharge roller 25, and a frame 26.

The motor 21 is a drive source which rotates the platen roller P of the tape cartridge C loaded in the cartridge loading section 12. The gear train 22 transmits the motive power of the motor 21 to the platen roller P. That is, as the motive power of the motor 21 is transmitted to the platen roller P via the gear train 22, the platen roller P rotates. As the platen roller P rotates, the tape T sandwiched between the platen roller P and the print head 23 is carried toward the tape outlet 7. The print head 23 is a thermal-type head. As the print head 23 is driven to generate heat, an image is printed onto the tape T.

The tape cutter 24 cuts off the printed part of the tape T, for example, in the form of scissors. Also, the tape cutter 24 may operate by the motive power of the motor 21 or may be operated manually. The discharge roller 25 is provided near the tape outlet 7. The discharge roller 25 holds the tape T cut off after printing, that is, a tape piece Ta, in such a way that the tape piece Ta can be pulled out of the tape outlet 7.

The frame 26 supports the motor 21, the gear train 22, the print head 23, the tape cutter 24, and the discharge roller 25. That is, the respective parts of the printing unit 13 are unified via the frame 26. As the material of the frame 26, the use of a resin may be considered in order to reduce the weight. However, it is preferable to use a sheet metal (sheet steel) in order to secure enough strength.

The battery accommodation section 14 is provided next to the far side of the printing unit 13. In other words, the battery accommodation section 14 is provided substantially in a middle part of the handheld printing device 1, in the longitudinal direction. A battery (not illustrated) is accommodated in the battery accommodation section 14.

The power supply unit 15 is provided to the far side of the printing unit 13. The power supply unit 15 supplies electricity with an appropriate output voltage to each part of the handheld printing device 1 on the basis of the power supplied from the battery accommodated in the battery accommodation section 14. The power supply unit 15 has a power supply circuit board and circuit elements such as a capacitor mounted on the power supply circuit board.

The control unit 16 is provided to the far side of the printing unit 13, along with the power supply unit 15. The control unit 16 controls each part of the handheld printing device 1. The control unit 16 has a control circuit board, and a CPU (central processing unit) and circuit elements such as various memories mounted on the control circuit board.

As described above, according to the handheld printing device 1 of this embodiment, the printing unit 13 is provided on the near side of the handheld printing device 1. Therefore, the respective components of the printing unit 13 including weighty objects such as the motor 21 and the frame 26 can be put together and thus arranged on the near side of the handheld printing device 1. Thus, the center of gravity of the handheld printing device 1 can be situated on the near side of the handheld printing device 1 and the weight balance of the handheld printing device 1 can be improved. That is, the concentration of the mass can be achieved in the handheld printing device 1. Therefore, when the user grips the grip part 3 provided on the near side of the handheld printing device 1, the handheld printing device 1 can be restrained from wobbling and the user can grip the handheld printing device 1 in a stable manner. Also, according to the handheld printing device 1 of this embodiment, the printing unit 13 is provided on the other side of the keyboard 5 from the operation surface 5a. Therefore, the size in the longitudinal direction of the handheld printing device 1 can be made smaller than in the case where the printing unit 13 is provided side by side with the keyboard 5 on the near side or on the far side.

According to the handheld printing device 1 of this embodiment, the tape outlet 7 is provided on the near-side surface of the casing 2. Therefore, the print result on the tape T discharged from the tape outlet 7 can be visually recognized more easily than in the case where the tape outlet 7 is provided on the far side of the casing 2. Also, the tape piece Ta with its tip exposed from the tape outlet 7 in the state of held by the discharge roller 25 can be easily picked up by the hand and taken out from the tape outlet 7.

According to the handheld printing device 1 of this embodiment, the battery accommodation section 14 is provided next to the printing unit 13. Therefore, the battery, which is a weighty object, can be put together and accommodated with the respective components of the printing unit 13 including weighty objects. Thus, the weight balance of the handheld printing device 1 can be improved.

According to the handheld printing device 1 of this embodiment, since the grip part 3 is provided on the near side of the handheld printing device 1, the user can easily grip the near-side part 9 of the handheld printing device 1.

According to the handheld printing device 1 of this embodiment, the cartridge loading section 12 is provided on the near side of the handheld printing device 1. Therefore, the tape cartridge C can be put together and accommodated with the respective components of the printing unit 13 including weighty objects. Thus, even in the case where the tape cartridge C is a relatively weighty object, the weight balance of the handheld printing device 1 can be improved.

According to the handheld printing device 1 of this embodiment, the keyboard 5 is provided on the near side of the handheld printing device 1. Therefore, at the time of an input operation on the keyboard 5, the pressing force on the keyboard 5 from one hand of the user can be received by the other hand gripping the grip part 3 of the handheld printing device 1. Thus, the handheld printing device 1 can be restrained from wobbling during the input operation on the keyboard 5.

The invention is not limited to the above embodiment, and as a matter of course, various configurations can be employed without departing from the scope of the invention. For example, the embodiment can be modified in the following forms.

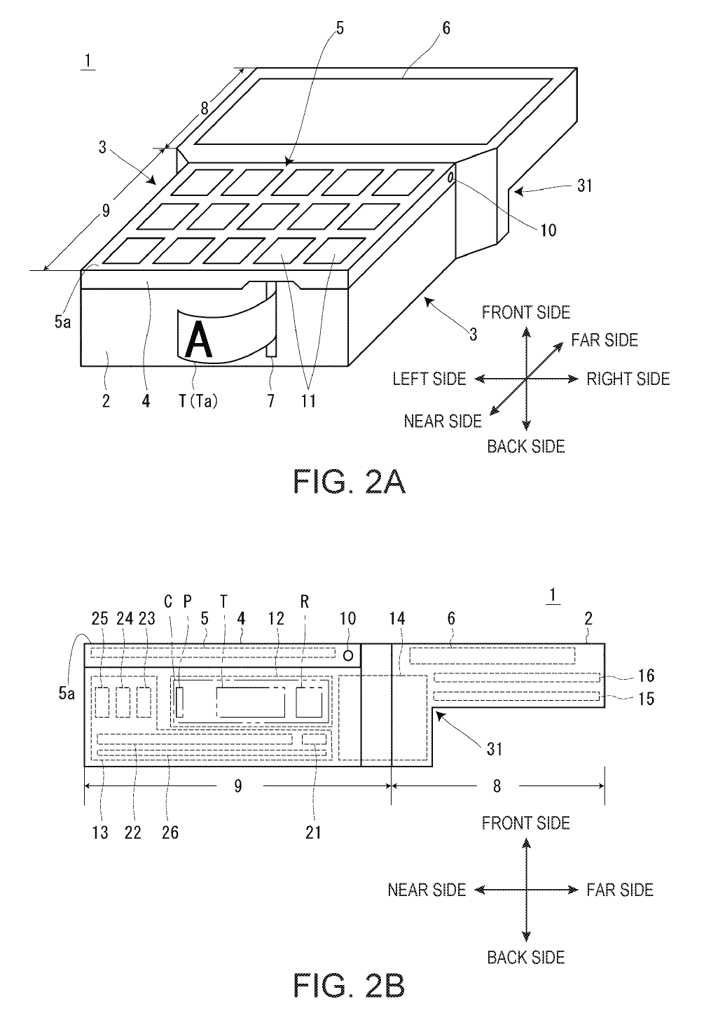

As shown in FIG. 2, the far-side part 8 of the handheld printing device 1 may be thinner than the near-side part of the handheld printing device 1, via a step part 31 provided on the side opposite to the front side where operation surface 5a is provided, that is, on the back side. According to this configuration, when the user grips the grip part 3 of the handheld printing device 1, the user can place a finger on the step part 31 provided on the back side of the handheld printing device 1. Thus, the easiness of grip of the handheld printing device 1 can be improved.

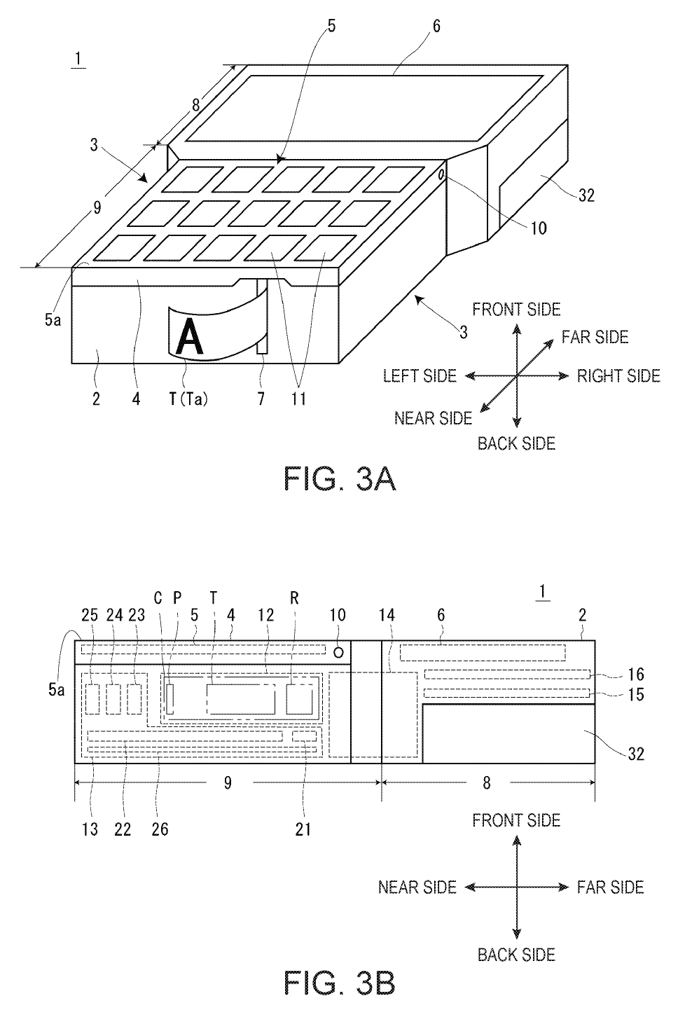

As shown in FIG. 3, an accommodation section 32 may be provided on the far side and back side of the handheld printing device 1. In this case, it is preferable that, when the accommodation section 32 is excluded from the view, the far-side part 8 of the handheld printing device 1 is thinner than the near-side part 9 of the handheld printing device 1 via the step part 31 provided on the back side, similarly to the modification shown in FIG. 2. Thus, even in the case where the accommodation section 32 is provided on the near side of the handheld printing device 1, the entirety of the handheld printing device 1 can be formed into a compact shape.

Also, an arbitrary object such as the tape piece Ta taken out of the tape outlet 7, a spare tape cartridge C, or a spare battery can be accommodated in the accommodation section 32.

In the case where the tape outlet 7 is provided on the near side of the handheld printing device 1, the tape outlet 7 is not limited to the near-side surface and may be provided on any of the right lateral surface, the left lateral surface, the front surface, and the back surface, or may be provided over a plurality of surfaces.

A touch panel display may be provided instead of the keyboard 5 and the display 6, and the touch panel display may be made to function as an input unit and a display unit. In this case, the touch panel display may be provided, for example, on the entire front surface or on the far side of the handheld printing device 1. However, as described above with respect to the keyboard 5, it is preferable that the touch panel display is provided on the near side of the handheld printing device 1 in view of operability.

The open/close cover 4 may be provided not on the front surface of the handheld printing device 1 but on the other surfaces such as the back surface. In this case, the display 6 is separated from the open/close cover 4 and provided on the front surface of the handheld printing device 1.

The platen roller P feeding the tape T may be provided not on the side of the tape cartridge C but on the side of the handheld printing device 1, that is, in the printing unit 13. Also, the tape T need not be loaded in the handheld printing device 1 as the tape cartridge C, and the tape T itself may be configured to be loaded in the handheld printing device 1. As the print medium, a sheet roll, a single-sheet paper or the like can be used as well as the tape T.

1. A handheld-type printing device comprising:
an operation unit provided on a first surface side of the printing device; and
a printing unit which prints an image on a print medium;
wherein the printing unit is provided on a second surface side opposite to the first surface side, where the operation unit is provided, and on a near side at the time of operating the operation unit.

2. The printing device according to claim 1, further comprising a casing
where the printing unit is accommodated,
wherein a medium outlet through which the print medium that is printed is discharged is provided in the casing, and
the medium outlet is provided on the near side at the time of operating the operation unit.

3. The printing device according to claim 1, further comprising a battery accommodation section where a battery is accommodated, next to the printing unit.

4. The printing device according to claim 1, wherein the second surface side of the printing device has a step on a far side at the time of operating the operation unit, compared with the near side at the time of operating the operation unit.

5. The printing device according to claim 1, further comprising a grip part extending in a direction intersecting with the first surface and the second surface and provided on the near side at the time of operating the operation unit.

6. The printing device according to claim 1, further comprising a loading section for setting the print medium in the printing unit, on the first surface side and on the near side at the time of operating the operation unit.

7. The printing device according to claim 1, wherein an input unit for inputting information to be printed on the print medium is provided in the operation unit.

8. The printing device according to claim 4, wherein a display unit is provided on the far side at the time of operating the operation unit and on the first surface side.

9. The printing device according to claim 1, wherein the printing unit comprises:
a motor which serves as a drive source for rotating a roller feeding the print medium;
a gear train which transmits a motive power of the motor to the roller;
a frame which supports the gear train; and
a print head which prints an image on the print medium.
